(19) United States
(12) Patent Application Publication
(10) Pub. No.: US 2026/0218074 A1
(43) Pub. Date: Jul. 30, 2026

(54) INTEGRATED SCRUBBING OPERATIONS FOR PROCESSING OF SYNGAS FROM GASIFICATION

(71) Applicant: SunGas Renewables, Inc., Houston, TX (US)

(72) Inventors: Matthew SPICER, Pearland, TX (US); Terry HUGHES, Jersey Village, TX (US); Clifton G. KEELER, Spring, TX (US)

(21) Appl. No.: 19/145,588

(22) PCT Filed: Jan. 5, 2024
(86) PCT No.: PCT/US2024/010403

§ 371 Date: Jul. 3, 2025

Related U.S. Application Data
(60) Provisional application No. 63/437,199, filed on Jan. 5, 2023.

(51) Int. Cl. C10K 3/04; C10J 3/02

(52) U.S. Cl. CPC C10K 3/04; C10J 3/02; C10J 2300/0916; C10J 2300/093; C10J 2300/0953

(57) ABSTRACT

Processes are disclosed for the gasification of carbonaceous feeds and preferably biomass, which can implement one or more strategies for removing contaminants, particularly chlorides and ammonia, with reduced negative impacts on overall processing objectives. These objectives can include obtaining a syngas product, with sufficient purity and hydrogen content or H₂:CO molar ratio, that favor downstream conversion and/or separation operations as needed to generate value-added products (e.g., hydrocarbons, alcohols such as methanol, RNG, or renewable, purified hydrogen). According to certain aspects, heat and/or material integration of (i) contaminant removal with (ii) other operations of the gasification process can lead to further efficiencies. Metallurgical requirements over conventional processes may be reduced.

### CROSS REFERENCE TO RELATED APPLICATIONS

This application claims the benefit of priority to U.S. Provisional Application No. 63/437,199, filed Jan. 5, 2023, which is hereby incorporated by reference in its entirety.

### FIELD OF THE INVENTION

Aspects of the invention relate to gasification processes in which water-soluble contaminants, such as chlorides and ammonia that are present in the gasifier effluent, are removed by scrubbing operations, which may include chloride and ammonia scrubbers that are integrated upstream and downstream, respectively, of a water-gas shift operation.

### DESCRIPTION OF RELATED ART

The gasification of coal has been performed industrially for over a century in the production of synthesis gas (syngas) that can be further processed into transportation fuels. More recent efforts toward developing energy independence with reduced greenhouse gas emissions have led to a strong interest in using biomass as a gasification feed, and thereby an alternative potential source of synthesis gas, as well as its downstream conversion products. Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which is often referred to as synthesis gas because of its H₂ and CO content, must be cooled significantly and treated to remove a number of undesired components. These include particulates, as well as byproducts of gasification that are generally referred to as tars and oils and that have a propensity to condense on, coat, and foul internal surfaces of process piping and equipment.

Furthermore, downstream conversion of the synthesis gas to value-added products often requires its hydrogen content to be increased, relative to that obtained from gasification alone. As an alternative to the expense of adding pure hydrogen, the H₂:CO molar ratio of the synthesis gas can be increased for its subsequent use in a number of reactions, by performing the exothermic water-gas shift (WGS) reaction gas according to:

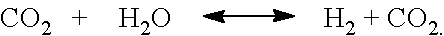

The thermodynamics of this reaction govern an equilibrium shift toward hydrogen production at lower temperatures, which are generally unfavorable from the standpoint of reaction kinetics. Another factor impacting performance is the concentration of steam in the WGS reaction feed, which directionally favors the intended H₂ production. However, operations conducted to purify the gasifier effluent, or synthesis gas, in preparation for the catalytic WGS reaction, can lead to substantial cooling of this stream and/or cause its dehydration, such that process efficiency must be sacrificed to thereafter “restore” conditions, as needed to achieve acceptable conversion levels and associated hydrogen concentrations. This is practiced, for example, when gasifier-produced synthesis gas, having been treated to remove tars and oils at elevated temperatures, is then scrubbed to remove water-soluble contaminants, causing significant reductions in its heat and moisture content. These properties must then be re-established, such as through the addition of a large amount of steam to attain satisfactory performance of the WGS reaction.

The purification of syngas is necessary to prevent deactivation of catalyst used not only in the WGS operation, but also in downstream conversion operations including Fischer-Tropsch synthesis to produce hydrocarbons, the conversion of syngas to methanol, and methanation for production of renewable natural gas (RNG) or biomethane. To this end, the removal of contaminants resulting from small quantities of heteroatoms (e.g., Cl, N, and S) found in carbonaceous feeds, and generally the hydrogenated forms of such contaminants (e.g., HCl, NH₃, H₂S), must be carefully managed at various stages of the overall gasification process. Current practices in this regard utilize a single scrubber vessel, following gasification with subsequent tar removal (e.g., via partial oxidation) and filtration. The scrubbed syngas leaving this vessel is in a non-ideal state for subsequent operations as noted above, with respect to its depleted heat and moisture content.

A number of technical challenges therefore exist with respect to requirements for heating, cooling, removal of tar and other contaminants, and H₂:CO molar ratio adjustment, as necessary to obtain a synthesis gas product suitable for subsequent conversion to higher value products. The further requirements for contaminant removal add yet another layer of complexity in view of associated changes in syngas quality, resulting from conventional purification measures. The present state of the art would benefit from managing contaminants in an improved manner, to reduce or eliminate certain adverse effects on the purified syngas that complicate its downstream processing.

### SUMMARY OF THE INVENTION

Aspects of the invention are associated with the discovery of gasification processes utilizing carbonaceous feeds and preferably biomass, which can implement one or more strategies for removing contaminants, particularly chlorides and ammonia, with reduced negative impacts on overall processing objectives. Such objectives can include obtaining a syngas product, with sufficient purity and hydrogen content or H₂:CO molar ratio, that favor downstream conversion and/or separation operations as needed to generate value-added products (e.g., hydrocarbons, alcohols such as methanol, RNG, or renewable, purified hydrogen). According to certain aspects, heat and/or material integration of (i) contaminant removal with (ii) other operations of the gasification process can lead to further efficiencies, but in any event improvements in overall process economics can be realized.

Particular aspects of the invention relate to the use of separate scrubbers for contacting syngas with aqueous media to remove (i) predominantly chlorides (e.g., in the form of HCl) and (ii) predominantly ammonia. The former, chloride scrubber, may be positioned upstream of a water-gas shift (WGS) operation, whereas the latter, ammonia scrubber, may be positioned downstream of such WGS operation. The efficiency of scrubbing, and the gasification process overall, may be improved through integration between (i) the scrubbers themselves and/or (ii) a scrubber and other process operations. For example, (i) may be performed by utilizing an aqueous product of the ammonia scrubber as at least a portion of the aqueous feed to the chloride scrubber. This can improve efficiency of chloride contaminant removal, through acid-base chemistry such as by formation of ammonium chloride, in view of the aqueous product of the ammonia scrubber being basic. Other advantages may be gained from ammonia acting as a buffer against strongly acidic HCl, thereby lessening overall acidity of the aqueous chloride scrubber product (e.g., contained in, and exiting from, a bottoms section of the chloride scrubber). In the case of (ii), this may be performed, for example, by utilizing an aqueous product of either the chloride scrubber or the ammonia scrubber for directly or indirectly cooling the gasifier effluent (e.g., directly in a quenching operation or indirectly in a convective or radiant syngas cooler).

Further aspects are associated generally with the recognition of advantages that can be derived from operating separate scrubbers under separate conditions, such as in the case of a chloride scrubber, upstream of the WGS operation, utilizing a higher temperature compared to that of an ammonia scrubber, downstream of the WGS operation. Importantly, typical catalysts used in the WGS operation can tolerate ammonia but not chlorides, and therefore a “split” scrubbing of water-soluble contaminants, namely via separate steps of predominantly chloride removal and predominantly ammonia removal, upstream and downstream of the WGS operation, respectively, leads to advantages. These are associated with “focused” removal of those contaminants, upstream of the WGS operation, which are most detrimental to this operation (e.g., the catalyst used in this operation), without requiring extensive dehydration of the scrubbed gas that is subsequently subjected to the WGS reaction. In particular, desirably high moisture levels and temperatures of the chloride-depleted syngas exiting the chloride scrubber can be maintained, for processing via the catalytic WGS reaction, prior to ammonia removal. Increasing moisture level, or H₂O concentration, directionally favors hydrogen production via the WGS reaction from a thermodynamic standpoint. The higher temperature of operation of the chloride scrubber can refer more particularly to the temperature at or near the gas outlet of this vessel, since the temperature of the chloride-depleted syngas exiting the chloride scrubber governs the moisture level of this process stream, depending also on total operating pressure. In some embodiments, the gas outlet temperature of the chloride scrubber exceeds the gas outlet temperature of the ammonia scrubber, and may even exceed the temperature the ammonia scrubber generally (e.g., the temperature at all locations throughout this vessel).

By maintaining desirably high moisture levels and temperatures of the chloride-depleted syngas, at least a portion of which may be fed to the WGS operation, advantages are gained over conventional gas scrubbing (e.g., to remove water-soluble contaminants generally) that may involve the use of lower scrubber temperatures and consequently the need to add steam, or a relatively greater quantity of steam, prior to the WGS operation. For example, in the case of a feed to the WGS operation having a desirable H₂O:syngas molar ratio of 1:1 (i.e., a moisture level of 50 vol-%), conventional gas scrubbing upstream of this operation may require this feed, namely the scrubbed effluent, to be supplemented with a quantity of steam corresponding to a majority of the needed moisture. By utilizing “split” scrubbing of water-soluble contaminants as described herein, this supplemental quantity of steam may be reduced or even eliminated. Such decrease in steam consumption may be realized in the case of the WGS operation being performed as either a “sweet shift” at low sulfur concentrations or a “sour shift” at elevated sulfur concentrations, with the latter operation typically requiring at least about 300 ppm by volume of total sulfur, as needed for sulfiding the sour WGS catalyst to maintain its activity. A sour shift can be accommodated because sulfur removal occurs predominantly in the ammonia scrubber, downstream of the WGS operation, due to the lower operating temperature of this scrubber relative to that of the chloride scrubber. Accordingly, amounts of H₂S addition, as well as amounts of steam addition, can be reduced for sour shift operation, in the case of split scrubbing compared to conventional scrubbing. This is important for biomass gasification processes, in which added flexibility for operating with a sour shift is realized, for improved management of sulfur contaminants in the gasifier effluent (e.g., H₂S, COS) and for providing an overall more robust design to handle carbonaceous feeds of varying quality. In any event, processes described herein may beneficially employ residual heat of gasification (e.g., in a gasifier effluent following cooling and filtering) for the purpose of vaporizing water in the chloride scrubber, with the result of providing a higher moisture content feed to the WGS operation.

More specifically with respect to the significance of the temperature at or near the gas outlet of the chloride scrubber, adjusting this temperature can be particularly beneficial in terms of regulating the moisture level of the chloride-depleted syngas exiting this vessel, in view of at least a portion of this syngas being fed to the WGS operation that is thermodynamically impacted by H₂O concentration as noted above. Considering that the chloride-depleted syngas is saturated at the gas outlet of the chloride scrubber, its moisture level, or water vapor volume percentage, will provide a water vapor partial pressure (water vapor volume percentage times total operating pressure) corresponding to the vapor pressure of pure water at the temperature the chloride-depleted syngas, at or near the gas outlet of the chloride scrubber. Accordingly, particular embodiments of the invention are directed to gasification processes comprising adjusting a temperature of the chloride-depleted syngas obtained from the chloride scrubber (e.g., at or near its gas outlet) to control (e.g., maintain) a setpoint moisture level (humidity) of the chloride-depleted syngas.

In the case of positioning a WGS operation between separate scrubbers, this can allow further improvements in processing flexibility and integration, by bypassing the WGS operation with a portion of the effluent from the first scrubber (e.g., the chloride scrubber), to control the hydrogen content and/or H₂:CO molar ratio of the treated syngas product obtained from passage through both scrubbers. This bypassing, coupled with feed/effluent heat exchange around the WGS operation, can also be used for added temperature control, for example of the H₂-enriched syngas being fed to the second scrubber (e.g., the ammonia scrubber). In this regard, the performance of the scrubbers is dependent on temperature, with the ammonia scrubber normally operating more efficiently (i.e., with increased ammonia removal in the case of all other processing variables being held constant) at lower temperatures, over practical temperature ranges of interest. The feed/effluent heat exchange, if implemented, can beneficially recover heat from the exothermic WGS reaction to provide at least some of the heat requirements of the feed, such as the saturated, chloride-depleted syngas, to the WGS operation. This integrates gasification heat with the H₂-enriched syngas obtained from the WGS operation.

Consistent with these findings, particular embodiments of the invention are directed to gasification processes comprising feeding at least a first portion of the chloride-depleted syngas to a WGS operation to provide an H₂-enriched syngas and, in an ammonia scrubber, contacting the H₂-enriched syngas with an aqueous ammonia scrubber feed to provide a treated syngas product. Other particular embodiments are directed to such processes comprising feeding at least a first portion of the chloride-depleted syngas to a WGS operation to provide an H₂-enriched syngas and feeding at least a second portion of the chloride-depleted syngas (e.g., directly) to an ammonia scrubber, without subjecting the second portion to the WGS operation, i.e., in the case of bypassing the WGS operation, without increasing the H₂ content of the second portion (enriching this portion in H₂).

Yet other advantages of “split” scrubbing of water-soluble contaminants, according to embodiments described herein, reside in avoiding the several potential layers of pumps and heat exchangers required in the case of using only a single scrubber. With separate scrubbers serving predominantly separate purposes, the bottoms sections of each scrubber can utilize simple liquid level control with a drawoff (e.g., blowdown letdown), as opposed to a more complicated, circulating water loop that is conventionally used for separating the operation of scrubbers. In this manner, the risk of chloride contacting the pumps and other equipment associated with the ammonia scrubber is significantly reduced. This alleviates requirements, for equipment in hydrochloric acid service, pertaining to upgraded metallurgy that can involve considerable expense. Maintenance costs may also be reduced, in view of bottoms scrubber pumps and heat exchangers normally having the highest concentration of metallic ions that contribute to wearing of this equipment, decreasing service life. The use of separate scrubbers, as opposed to a single, connected scrubber, can therefore result in reduced costs, in terms of both capital (equipment) expenditures (e.g., due to lower metallurgy/corrosion resistance requirements) and operating expenses.

Overall advantages of various embodiments described herein relate to added processing flexibility associated with the removal of contaminants from syngas, which is gained from the use of separate scrubbers and associated operating conditions that can be manipulated to achieve desired processing parameters (e.g., moisture levels and temperatures). These and other embodiments, aspects, and advantages relating to the present invention are apparent from the following Detailed Description.

### BRIEF DESCRIPTION OF THE DRAWING

A more complete understanding of the exemplary embodiments of the present invention and the advantages thereof may be acquired by referring to the following description in consideration of the accompanying figures, in which the same reference numbers are used to identify the same features.

FIG. 1 depicts a flowscheme illustrating an embodiment of a process for the gasification of a carbonaceous feed, which process employs a number of possible features as described herein, including scrubbing to remove water-soluble contaminants.

FIG. 2 depicts a flowscheme illustrating certain aspects in more detail, such as flows of aqueous streams about the chloride scrubber and ammonia scrubber, as well as auxiliary heaters and coolers that may be employed.

For the sake of simplicity, multiple features are illustrated and described in each of the figures, with the understanding that not all features (e.g., not all individual operations and their associated process streams and equipment) are required and that various specific features can be implemented independently of others.

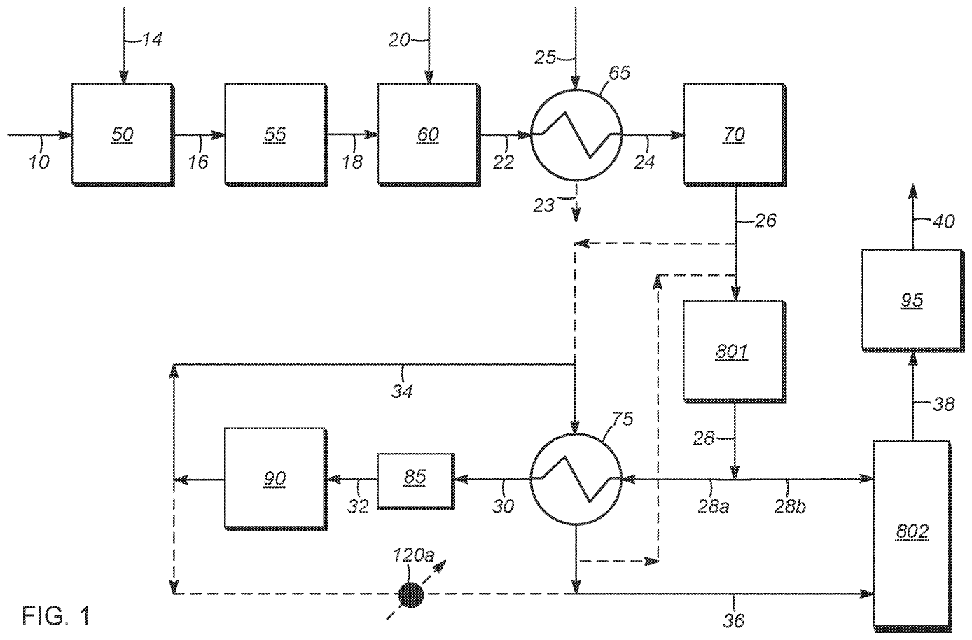

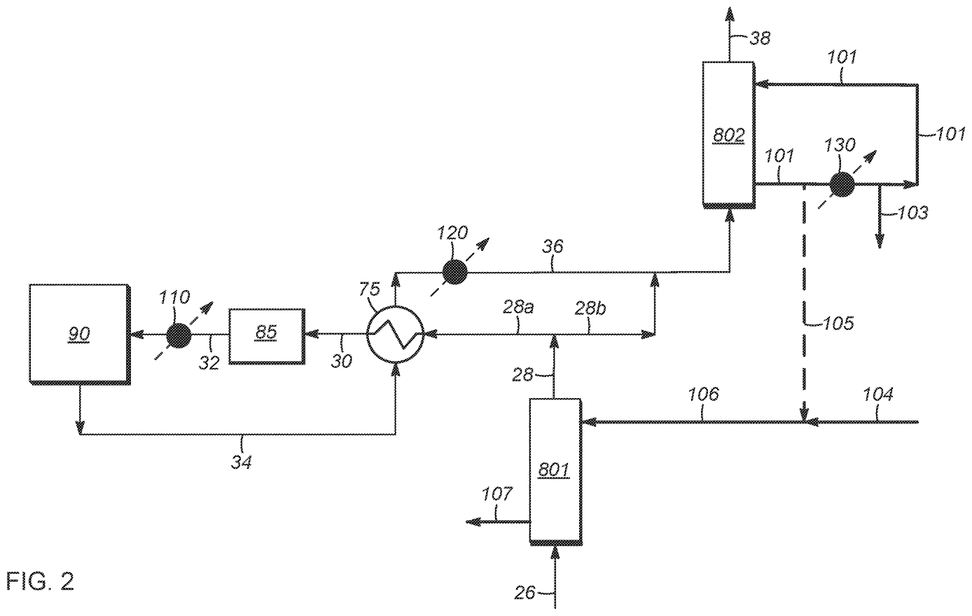

In order to facilitate explanation and understanding, FIGS. 1 and 2 provide an overview of these and other features for implementation in gasification processes. Some associated equipment such as certain vessels, heat exchangers, valves, instrumentation, and utilities, are not shown, as their specific description is not essential to the implementation or understanding of the various aspects of the invention. Such equipment would be readily apparent to those skilled in the art, having knowledge of the present disclosure. Other processes for producing syngas and/or its conversion products such as renewable liquids, according to other embodiments within the scope of the invention and having configurations and constituents determined, in part, according to particular processing objectives, would likewise be apparent.

### DETAILED DESCRIPTION

The expressions “wt-%” and “vol-%,” are used herein to designate weight percentages and volume percentages, respectively. The expressions “wt-ppm” and “vol-ppm” designate weight and volume parts per million, respectively. For ideal gases, “vol-%” and “vol-ppm” are equal to molar percentages (mol-%) and molar parts per million (mol-ppm), respectively.

The term “substantially,” as used herein, refers to an extent of at least 95%. For example, the phrase “substantially all” may be replaced by “at least 95%.” The phrases “all or a portion” or “at least a portion” are meant to encompass, in certain embodiments, “at least 50% of,” “at least 75% of,” “at least 90% of,” and, in preferred embodiments, “all.” Likewise, designated portions, such as a “first portion” or “second portion” may represent these percentages (but not all) of the total, and particularly these percentages (but not all) of the total process stream to which they refer.

Reference to any starting material, intermediate product, or final product, which are all preferably process streams in the case of continuous processes, should be understood to mean “all or a portion” of such starting material, intermediate product, or final product, in view of the possibility that some portions may not be used, such as due to sampling, purging, diversion for other purposes, mechanical losses, etc. Therefore, for example, the phrase “contacting the gasifier effluent with an aqueous chloride scrubber feed” should be understood to mean “contacting all or a portion of the gasifier effluent with all or a portion of an aqueous chloride scrubber feed.” As in the case of “all or portion” being expressly stated, when this phrase is the understood meaning, it also encompasses certain and preferred embodiments as noted above.

Representative processes described herein for the gasification of a carbonaceous feed may comprise a number of unit operations, with one of such operations stated as being performed or carried out “before,” “prior to,” or “upstream of” another of such operations, or with one of such operations being performed or carried out “after,” “subsequent to,” or “downstream of,” another of such operations. These quoted phrases, which refer to the order in which one operation is performed or carried out relative to another, are in reference to the overall process flow, as would be appreciated by one skilled in the art having knowledge of the present specification. More specifically, the overall process flow can be defined, with reference to the drawing figures, by the bulk gasifier effluent flow, encompassing bulk flows of streams designated with “gasifier effluent” (e.g., “filtered gasifier effluent”), “syngas” (e.g., “chloride-depleted syngas”), and “WGS” (e.g., “WGS feed”), as such flow(s) is/are subjected to operations as defined herein. Insofar as the quoted phrases above are used to designate order, in specific embodiments these phrases mean that one operation immediately precedes or follows another operation, whereas more generally these phrases do not preclude the possibility of intervening operations. Therefore, for example, a description, or illustration in the figures, of the filtration operation being downstream of the quenching operation refers, according to a specific embodiment, to the filtration operation immediately following the quenching operation. However, this description or illustration more generally, and preferably, means that one or more intervening operations (e.g., a convective syngas cooler (CSC), according to the embodiment illustrated in the Figure) can be performed or carried out between these operations. Therefore, to the extent that representative processes described herein are defined as including certain unit operations, unless otherwise stated or designated (e.g., by using the term “directly” or the phrase “consisting of”), such processes do not preclude the use of other operations, whether or not specifically described herein.

Specific processes described herein are defined by a gasifier, a chloride scrubber downstream of the gasifier, and a WGS operation downstream of the chloride scrubber. The gasifier provides a “gasifier effluent”; the chloride scrubber provides a “chloride-depleted syngas,” a portion of which may provide a “WGS feed”; and the WGS operation provides an “H₂-enriched syngas.” The term “gasifier effluent” is a general term that refers to the effluent of the gasifier, whether or not having been subjected to one or more operations downstream of the gasifier and upstream of the chloride scrubber.

The term “gasifier effluent” may therefore encompass more specific terms that designate (i) the effluent provided directly by the gasifier, i.e., the “raw gasifier effluent,” (ii) the raw gasifier effluent having been subjected to at least a tar removal operation, i.e., a “tar-depleted gasifier effluent,” having a lower concentration of tars and oils relative to the raw gasifier effluent, (iii) the raw gasifier effluent having been subjected to at least a dry quenching operation, i.e., a “quenched gasifier effluent,” having a lower temperature and higher moisture (H₂O) concentration relative to the raw gasifier effluent, resulting from direct quenching (e.g., partial quenching) with water, (iv) the raw gasifier effluent having been subjected to at least a convective syngas cooler (CSC), i.e., a “cooled gasifier effluent” having a lower temperature relative to the raw gasifier effluent, resulting from heat transfer for external steam generation, (v) the raw gasifier effluent having been subjected to at least a filtration operation, i.e., a “filtered gasifier effluent,” having a lower solid particle content relative to the raw gasifier effluent, and (vi) the raw gasifier effluent having been subjected to any other operation upstream of the chloride scrubber, whether or not specifically described herein.

Likewise, the term “WGS feed” may encompass more specific terms that designate (i) a portion of the chloride-depleted syngas provided directly by the chloride scrubber and directed to the WGS operation, i.e., the “WGS-feed portion,” (ii) the WGS-feed portion having been subjected to at least heating upstream of the WGS operation, for example by indirect heat exchange with H₂-enriched syngas provided by the WGS operation, i.e., the “heated WGS portion,” (iii) the WGS-feed portion having been subjected to at least supplemental chloride removal upstream of the WGS operation, for example by treatment with a chloride guard bed, and (iv) the WGS-feed portion having been subjected to any other operation upstream of the WGS operation, whether or not specifically described herein. The term “H₂-enriched syngas” may refer to the hydrogen-enriched syngas provided directly by the WGS operation (e.g., the effluent of a reactor of this operation), such hydrogen-enriched syngas having been subjected to at least cooling upstream of the ammonia scrubber, for example by indirect heat exchange with the WGS-feed portion, i.e., the “cooled H₂-enriched syngas,” and such hydrogen-enriched syngas having been subjected to any other operation upstream of the ammonia scrubber, whether or not specifically described herein. The terms “syngas,” or alternatively “synthesis gas product,” insofar as they relate to streams comprising H₂ and CO, are used herein to generally refer to any of the “gasifier effluent,” “WGS feed,” and “H₂-enriched syngas” as described above, in addition to a “treated syngas product.”

The term “treated syngas product” is a general term that refers to a product obtained by scrubbing in both a chloride scrubber and an ammonia scrubber to remove the designated contaminants, and may in particular embodiments refer to the product provided directly by the ammonia scrubber or otherwise such product having been subjected to another operation, for example upstream of a syngas conversion operation. Accordingly, all or a portion of the treated syngas product may, in particular embodiments, be fed to a syngas conversion operation or a syngas separation operation to provide as a value-added product, a renewable syngas conversion product or a renewable syngas separation product.

Particular examples of renewable syngas conversion products and renewable syngas separation products include both renewable liquid products (e.g., liquid hydrocarbons or methanol) and renewable gaseous products (e.g., renewable natural gas (RNG) or renewable hydrogen). Representative syngas conversion operations, to obtain a syngas conversion product, may comprise a Fischer-Tropsch reaction stage, a methanol synthesis reaction stage, or a methanation reaction stage. Representative syngas separation operations, to obtain a syngas separation product, may comprise a hydrogen purification stage, such as in the case of syngas separation by pressure swing adsorption (PSA) and/or the use of a membrane. Any such syngas conversion operation or syngas separation operation is preferably performed downstream of a WGS operation that can yield an increased, and more favorable, H₂:CO molar ratio, in terms of efficiently performing the desired conversion or separation.

In achieving various objectives and associated advantages as described herein, particular embodiments of the invention are directed to processes for gasification of a carbonaceous feed, in order to produce a synthesis gas product and/or optionally a downstream renewable syngas conversion product (e.g., liquid hydrocarbons or methanol) or downstream renewable syngas separation product (e.g., purified hydrogen), following reaction or separation of the synthesis gas product. A representative process comprises, in a gasifier, contacting the carbonaceous feed with an oxygen-containing gasifier feed, under gasification conditions, to provide a gasifier effluent comprising, as a synthesis gas, H₂, CO, and water-soluble contaminants. Such contaminants may include chlorides (e.g., HCl) and nitrogen-containing compounds (e.g., ammonia) that originate from small amounts of Cl and N present in the carbonaceous feed. As noted above, this gasifier effluent may be more particularly characterized as any one of a raw gasifier effluent, a tar-depleted gasifier effluent, a quenched gasifier effluent, a cooled gasifier effluent, or a filtered gasifier effluent.

The processes may further comprise, in a chloride scrubber, contacting the gasifier effluent with an aqueous chloride scrubber feed to provide a chloride-depleted syngas, exiting a gas outlet of the chloride scrubber. Representative processes may further comprise adjusting or maintaining a temperature of the chloride-depleted syngas, such as the temperature at or near the gas outlet, to control (e.g., maintain) a setpoint moisture level (humidity) of the chloride-depleted syngas. Such moisture level may be that which provides favorable performance characteristics (e.g., conversion to hydrogen) in a subsequent WGS operation. A representative setpoint moisture level may be any discreet value in the range from about 20 vol-% to about 80 vol-%, such as from about 30 vol-% to about 70 vol-% (e.g., a setpoint moisture level of 50 vol-%). Representative temperatures of the chloride-depleted syngas to obtain such moisture levels may be in the range from about 100° C. (212° F.) to about 250° C. (482° F.), such as from about 120° C. (248° F.) to about 200° C. (392° F.), and will generally depend on the operating pressure of the chloride scrubber, and more particularly the pressure at the gas outlet of the chloride scrubber.

Advantageously, adjusting or controlling the temperature of the gas outlet of the chloride scrubber, allows for control of the moisture level of the chloride-depleted syngas. This temperature may be adjusted or controlled, for example, by external sources providing indirect heating and/or cooling, or otherwise may be adjusted or controlled by varying a flow rate of the aqueous feed to the chloride scrubber (e.g., entering the chloride scrubber at an axial height near the gas outlet, such as at or near the top of the chloride scrubber, in the case of a counter-current scrubber), depending on the temperature of this aqueous feed. As further described herein, this aqueous feed may comprise an aqueous product of the ammonia scrubber.

For example, the setpoint moisture level may be an estimated level, based on the relationship between temperature and water vapor pressure, which in turn equates to the partial pressure of water (water vapor volume percentage times total operating pressure) in the chloride-depleted syngas exiting the chloride scrubber. This partial pressure corresponds to the vapor pressure of pure water. For example, in the case of a setpoint moisture level of 50 vol-% and an operating pressure of 11 bar absolute, the temperature of the chloride-depleted syngas at or near the gas outlet of the chloride scrubber should be adjusted to, or maintained at, a temperature corresponding to the boiling point of water at 5.5 bar absolute, or about 156° C. (312° F.). In view of this description, it can be appreciated that, directionally, higher temperatures of chloride-depleted syngas correspond to higher moisture levels at any given operating pressure, or more particularly pressure at the gas outlet of the chloride scrubber. Additionally, higher operating pressures of the vessel directionally require higher outlet temperatures to attain a given moisture level. Such higher temperatures, in turn, can lead to the availability of higher quality heat for steam generation or heat integration within the overall process.

In achieving other various objectives and associated advantages as described herein, other particular embodiments of the invention are directed to processes for gasification of a carbonaceous feed, in order to produce a synthesis gas product and/or optionally a downstream renewable syngas conversion product (e.g., liquid hydrocarbons or methanol) or downstream renewable syngas separation product (e.g., purified hydrogen), following reaction or separation of the synthesis gas product. A representative process comprises, in a gasifier, contacting the carbonaceous feed with an oxygen-containing gasifier feed, under gasification conditions, to provide a gasifier effluent as described herein comprising, as a synthesis gas, H₂, CO, and water-soluble contaminants as also described herein. The processes may further comprise, in a chloride scrubber, contacting the gasifier effluent with an aqueous chloride scrubber feed to provide a chloride-depleted syngas, exiting a gas outlet of the chloride scrubber. Additionally, such processes may further comprise feeding at least a first portion of the chloride-depleted syngas to a water-gas shift (WGS) operation to provide an H₂-enriched syngas. These processes may yet further comprise (a) in an ammonia scrubber, contacting the H₂-enriched syngas with an aqueous ammonia scrubber feed to provide a treated syngas product, and/or (b) feeding at least a second portion of the chloride-depleted syngas (e.g., directly) to an ammonia scrubber, without subjecting the second portion to the WGS operation (e.g., bypassing the WGS operation, without increasing the content of H₂ in the second portion/enriching the second portion in H₂).

Representative gasification processes described herein are defined by various possible operations, occurring downstream of the gasifier which may include a tar removal operation; operations for cooling, such as a quenching operation and/or a CSC; a filtration operation; a chloride scrubber; WGS feed/effluent heat exchange; a chloride guard bed; a WGS operation; an ammonia scrubber; and a syngas conversion operation. Certain possible features of the gasifier, as well as these downstream operations and their associated process streams and conditions, according to preferred embodiments and otherwise any embodiments as defined in the claims, as well as the embodiments illustrated in the FIGS. 1 and 2, are provided in the following description.

### Gasifier

Representative processes comprise, in a gasifier, contacting a carbonaceous feed with an oxygen-containing gasifier feed, under gasification conditions, to provide a gasifier effluent (e.g., a raw gasifier effluent) comprising synthesis gas.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is wood.

In the gasifier (or, more particularly, a gasification reactor of this gasifier), the carbonaceous feed is subjected to partial oxidation in the presence of an oxygen-containing gasifier feed, added in an amount generally limited to supply only 20-70% of the oxygen that would be necessary for complete combustion. The oxygen-containing gasifier feed will generally comprise other oxygenated gaseous components including H₂O and/or CO₂ that may likewise serve as oxidants of the carbonaceous feed. The oxygen-containing gasifier feed can refer to all gases being fed or added to the gasifier, or otherwise can refer to gas that is separate from other gases being fed or added, whether subsequently combined upstream of, or within, the gasifier. For example, the oxygen-containing gasifier feed may be introduced to the gasifier, along with steam, or a portion of steam, generated elsewhere in the process (e.g., CSC-generated steam) and used as a separate feed. Contacting of the carbonaceous feed with the oxygen-containing gasifier feed in the gasifier provides a gasifier effluent, and more particularly a raw gasifier effluent as the product directly exiting the gasifier. One or more reactors (e.g., in series or parallel) of the gasifier may operate under gasification conditions present in such reactor(s), with these conditions including a temperature of generally from about 500° C. (932° F.) to about 1000° C. (1832° F.), and typically from about 816° C. (1500° F.) to about 1038° C. (1900° F.). Other gasification conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi), or from about 0.5 MPa (72 psi) to about 2 MPa (290 psi).

Gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O- and/or CO₂-containing feeds, being fed upwardly through the particle bed. Exemplary types of fluidized beds include bubbling fluidized beds and entrained fluidized beds.

In addition to gasifier effluent tar, the raw gasifier effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in the Figure, the raw gasifier effluent 16 may be obtained directly from gasifier 50, prior to further operations as described herein.

The raw gasifier effluent, or any gasifier effluent having been subjected to one or more operations as described herein, may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent may be suitable for use in downstream syngas conversion operations (reactions or separations), such as (i) the conversion to a renewable syngas conversion product comprising higher molecular weight hydrocarbons and/or alcohols of varying carbon numbers via Fischer-Tropsch conversion or (ii) the conversion to a renewable syngas conversion product comprising methanol via a catalytic methanol synthesis reaction, or (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. More typically, however, a WGS operation is needed to achieve a favorable H₂:CO molar ratio, and/or a favorable H₂ concentration, for these or other downstream syngas conversion and separation operations. For example, the WGS operation may include parameters (e.g., reactor temperatures and/or catalyst types) for obtaining the highest yield/concentration of hydrogen, through consumption of CO present in the syngas upstream of this operation, in the case obtaining purified hydrogen as a renewable syngas separation product (e.g., by utilizing one or more PSA and/or membrane separation stages).

Independently of, or in combination with, the representative amounts (concentrations) of H₂ and CO above, the gasifier effluent may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent. That is, these non-condensable gases and any water may be present in the gasifier effluent in a combined amount of at least about 90 mol-%, at least about 95 mol-%, or even at least about 99 mol-%.

### Tar Removal Operation

The raw gasifier effluent, obtained directly from the gasifier, will generally comprise gasifier effluent tar, such that a tar removal operation is typically necessary for further processing. This gasifier effluent tar can include compounds that are referred to in the art as “tars” and “oils” and are more particularly hydrocarbons and oxygenated hydrocarbons having molecular weights greater than that of methane, which may be present in the gasifier effluent at concentrations ranging from several wt-ppm to several wt-%. Certain types of these compounds, having relatively high molecular weight, are further characterized by being problematic due to their tendency to condense at lower temperatures and coat internal surfaces of processing equipment, downstream of the gasifier, causing undesirable fouling, corrosion, and/or plugging. These compounds also interfere with subsequent processing steps, or syngas conversion operations, for upgrading synthesis gas to higher value products, which perform optimally (e.g., from the standpoint of stability) with pure feed gases.

Particular compounds that are undesirable for these reasons include hydrocarbons and oxygenated hydrocarbons having six carbon atoms or more (C6+ hydrocarbons and oxygenated hydrocarbons), with benzene, toluene, xylenes, naphthalene, pyrene, phenol, and cresols being specific examples. These compounds are typically present in the raw gasifier effluent in a total (combined) amount from 1-100 g/Nm³. The removal (e.g., by conversion) of these organic compounds is therefore generally necessary to avoid serious problems caused by their deposition over time. Other types of tars and oils, such as ethane, ethylene, and acetylene, will not condense from the gasifier effluent but will nonetheless “tie up” hydrogen and carbon, with the effect of reducing the overall yield of H₂ and CO as the desired components of synthesis gas.

Depending on the specific tar removal operation, tars and oils in the raw gasifier effluent can be converted, either catalytically or non-catalytically, by oxidation, cracking, and/or reforming to provide, in the tar-depleted gasifier effluent, additional H₂ and CO. The tar conversion reaction(s) can utilize available O₂ or oxygen sources (e.g., H₂O and/or CO₂) that are present in, and/or added to, the synthesis gas. In view of the gasifier effluent tar, together with methane, containing a significant portion of the energy of the raw gasifier effluent, the conversion of these compounds can increase the overall yield of synthesis gas substantially. The tar removal operation, which may therefore, according to certain embodiments, be more specifically a tar conversion operation, can effectively reduce the concentration of compounds present as tar in the raw gasifier effluent, having been produced in the gasifier. In general, tar removal, and more particularly tar conversion reactions, may be performed under higher temperatures compared to those used in the gasifier, such that the tar-depleted gasifier effluent, obtained directly from the tar removal operation, may have a temperature of greater than about 1000° C. (e.g., from about 1000° C. (1832° F.) to about 1500° C. (2732° F.), such as from about 1204° C. (2200° F.) to about 1427° C. (2600° F.)).

According to one embodiment, the tar removal operation may be used for the conversion (e.g., reforming) of tar and methane through non-catalytic partial oxidation (Pox) in a reactor used for this operation. The efficiency of this specific operation can be promoted using hot oxygen burner (HOB) technology, according to which an excess of oxygen is mixed with a small amount of fuel (e.g., natural gas, propane, or recycled synthesis gas). Combustion of this fuel within the reactor can result in a temperature increase to above 1100° C. (2012° F.), causing the combustion products and excess oxygen to accelerate to sonic velocity through a nozzle, thereby forming a turbulent jet that enhances mixing between the tar/methane containing synthesis gas and the reactive hot oxygen stream. An HOB-based system can effectively improve synthesis gas yields, by converting methane and tars to additional H₂ and CO, together with the generation of heat.

In the case of a tar removal operation that utilizes catalytic conversion of tar and methane, this operation may include a reactor containing a bed of catalyst comprising solid or supported Ni, solid or supported Fe, and/or dolomite, for example in the form of a secondary fluidized bed downstream of the gasifier. Other catalysts for tar conversion include olivine, limestone, zeolites, and even metal-containing char produced from the gasification. As in the case of non-catalytic processes that may be performed in a tar removal operation, catalytic tar conversion may likewise include the introduction of supplemental oxygen and/or steam reactants, into a reactor used for this operation.

According to other particular embodiments, the tar removal operation may utilize a suitable liquid or solid adsorbent, to selectively adsorb tars and oils from the raw gasifier effluent. For example, the tar removal operation may be performed with an oil washing system, whereby the raw gasifier effluent is passed through (contacted with) a liquid medium such as bio-oil liquor, to extract the tars and oils based on their preferential solubility. The liquid adsorbent may be combusted after it has become spent.

Regardless of the particular method by which the tar removal operation is performed, the raw gasifier effluent may comprise tars and oils (e.g., present as compounds described above) in an amount, or combined amount, from about 0.01 wt-% to about 5 wt-%, such as from about 0.1 wt-% to about 3 wt-% or from about 0.5 wt-% to about 2 wt-%. The tar removal operation may be effective to substantially or completely remove this gasifier effluent tar. For example, the tar-depleted gasifier effluent exiting, or obtained directly from, this operation, may comprise tars and oils in an amount, or combined amount, of less than about 0.5 wt-%, less than about 0.1 wt-%, or less than about 0.01 wt-%. Representative levels of removal of tars and oils (e.g., by conversion), measured across the tar removal operation, may be at least about 90%, at least about 95%, or even at least about 99%, resulting in a tar-depleted gasifier effluent that may be substantially or completely free of tar.

### Quenching Operation

Hot gasifier effluent, for example the tar-depleted gasifier effluent exiting the tar removal operation, can be cooled by various techniques that include radiant and/or convective heat exchange. In representative embodiments, at least one quenching operation, and preferably a dry quenching operation, is used, in which water is added directly to the gasifier effluent and contributes to its overall moisture content, thereby favoring H₂ production via the equilibrium-limited WGS reaction (i.e., to provide an increased H₂:CO molar ratio and an increased H₂ concentration). A dry quenching operation utilizes the sensible heat of the gasifier effluent to vaporize the injected water, which is sufficient for obtaining the resulting quenched gasifier effluent at a desired, cooler temperature. In the case of avoiding the use of an RSC according to preferred embodiments, the quenched gasifier effluent may have a temperature from about 400° C. (752° F.) to about 900° C. (1652° F.), and preferably from about 538° C. (1000° F.) to about 816° C. (1500° F.) to allow for further processing. This can include, after sufficient further cooling (e.g., using a CSC) a subsequent filtration operation (passage through a filter) to remove solid particles (e.g., dust). In preferred embodiments, only a partial quench is used in the quenching operation, as opposed to a full quench, such that the quenched gasifier effluent exiting, or obtained directly from, the dry quenching operation is above its dewpoint, i.e., not saturated. In general, the dry quenching operation can promote rapid and efficient cooling through direct contact between hot gasifier effluent and water or other aqueous quenching medium.

### Convective Syngas Cooler (CSC)

As described herein, according to preferred embodiments, a combination of a quenching operation characterized by direct contact of a synthesis gas (e.g., the tar-depleted gasifier effluent exiting the tar removal operation) and a quenching medium such as water, together with a CSC, can provide effective cooling for further downstream operations, without reliance on an RSC for required removal of ash and formed slag. For example, a CSC may be used to cool a quenched gasifier effluent exiting the quenching operation to provide a cooled gasifier effluent, with the quenched gasifier effluent optionally having a temperature within a range as described above and/or the cooled gasifier effluent having temperature from about 250° C. (482° F.) to about 600° C. (1112° F.), and preferably from about 275° C. (527° F.) to about 350° C. (662° F.) to allow for subsequent filtration. A CSC may operate by indirect heat transfer, such as in the case of having a shell and tube configuration, and typically generates steam from some of the heat recovered from the gasifier and tar removal operation. According to more particular embodiments, a CSC operates as a boiler (e.g., a fire tube boiler or water tube boiler) for the production of high and/or intermediate pressure steam.

In general, (i) direct cooling, for example via a quenching operation; (ii) indirect cooling, for example via a CSC or radiant syngas cooler; or (iii) a combination of (i) and (ii), may be used to obtain a cooled gasifier effluent having a temperature within the representative ranges given above.

### Filtration Operation

A filtration operation, using any suitable filter, may be used to remove solid particles (particulates) from the gasifier effluent, for example the cooled gasifier effluent as described above. In the case of biomass gasification, these solid particles can include char, tar, soot, and ash, any of which can generally contain alkali metals such as sodium. Corrosive and/or harmful species such as chlorides, arsenic, and/or mercury may also be contained in such solid particles. A high temperature filtration, for example using bundles of metal or ceramic filters, may generally be sufficient to reduce the content of solid particles in the gasifier effluent, such as to provide a filtered gasifier effluent exiting, or obtained directly from, the filtration operation and having less than 1 wt-ppm, and possibly less than 0.1 wt-ppm of solid particles. In representative embodiments, the filtered gasifier effluent may have a temperature in a range as described above with respect to the cooled gasifier effluent.

In some embodiments, a filtration operation may be performed upstream of (prior to) the tar removal operation to allow the latter to operate more effectively. The removal of solid particles of varying average particles sizes, using filtration or other techniques, may be performed at any of a number of possible stages within the overall process. For example, coarse solids removal by centrifugation may be performed directly downstream of the gasifier, and/or may even be performed in situ in the gasifier (e.g., using internal cyclones, for removal of solid particles, positioned in a headspace above a fluidized particle bed). The filtration operation may be followed by, or integrated with, a supplemental cleaning operation to further purify the gasifier effluent, such as to further reduce its tar and overall hydrocarbon content, for example by contact with a solid “polishing” material such as a carbon bed. This can provide for more thorough removal of benzene, naphthalene, pyrene, toluene, phenols, and other condensable species that could otherwise be detrimental to downstream operations, such as by deposition onto equipment.

The filtration operation will generally not substantially impact the temperature of the process stream being filtered, such that, for example, the filtered effluent may have a temperature in a range as described above with respect to the cooled gasifier effluent.

### Chloride Scrubber

A chloride scrubber may be used to remove chlorides (e.g., HCl) from a gasifier effluent, such as a filtered gasifier effluent exiting the filtration operation. This removal may be achieved through contacting with a suitable aqueous stream, such as an aqueous chloride scrubber feed. Contacting may be performed in a counterflow manner, with the aqueous chloride scrubber feed entering, and the chloride-depleted syngas exiting, at or near the top of a vertically oriented (e.g., elongated cylindrical) chloride scrubber vessel. Contacting efficiency may be promoted by the use of internal structures, such as suitable packing material with a high surface area or discreet vapor-liquid contacting trays. Other types of contacting, such as bubbling of the gasifier effluent through the aqueous chloride scrubber feed (e.g., batchwise), co-current contacting, etc., may be carried out with the same result of obtaining a chloride-depleted syngas having a reduced amount (weight percentage or concentration) of total chloride relative to that of the gasifier effluent (e.g., filtered gasifier effluent) being fed to the chloride scrubber. Generally, the chloride scrubber is selective for removal of chlorides over other types of water-soluble contaminants such that, for example, chloride removal efficiency, under conditions present in the chloride scrubber, exceeds ammonia removal efficiency. However, this operation may nonetheless be effective for removing at least some ammonia and/or other water-soluble contaminants (e.g., H₂S and/or HCN), as well as some fine solid particles (e.g., char and ash) that may break through an upstream filtration operation. The chloride scrubber may be used to provide a chloride-depleted syngas effluent exiting, or obtained directly from, this operation and having a total HCl (or total chloride) content of less than about 10 wt-ppm, less than about 1 wt-ppm, and possibly less than about 0.1 wt-ppm.

The chloride scrubber may provide further cooling of the gasifier effluent being fed to the chloride scrubber, for example cooling of the filtered gasifier effluent beyond that achieved in upstream direct and/or indirect cooling, as described above. In representative embodiments, a chloride-depleted syngas exiting the chloride scrubber may have a temperature as described above, for example in the range from about 100° C. (212° F.) to about 250° C. (482° F.), such as from about 120° C. (248° F.) to about 200° C. (392° F.), with this temperature potentially bearing a relationship with operating pressure, as noted above.

### WGS Feed/Effluent Heat Exchange

According to some embodiments, such as those illustrated in FIGS. 1 and 2, at least a portion of the chloride-depleted syngas exiting the chloride scrubber, namely a WGS-feed portion, may be heated via indirect heat exchange. This heating may be performed using a WGS feed/effluent exchanger to transfer heat from H₂-enriched syngas exiting the WGS operation. According to an alternative embodiment illustrated by the dashed lines in FIG. 1, filtered gasifier effluent 26 from filtration operation 70 may provide a source of heat, by feeding to exchanger 75, to WGS-feed portion 28a of chloride-depleted syngas 28 exiting chloride scrubber 801. In this case, since exchanger 75 is not being used for cooling of H₂-enriched syngas 34, heat may be recovered from this stream for alternative purposes such as steam generation (e.g., via WGS effluent cooler 120a) or heat integration within the overall process. In any event, by virtue of heat transfer to the WGS-feed portion of the chloride-depleted syngas, this stream may be heated from a temperature in a range as described above, to a temperature of the resulting, heated WGS-feed portion in the range from about 225° C. (437° F.) to about 350° C. (662° F.), such as from about 250° C. (482° F.) to about 300° C. (572° F.). These higher temperatures are more favorable for inlet conditions of the WGS operation and thereby can reduce the duty associated with, or possibly eliminate the need for, added heating upstream of this operation, such as provided by an auxiliary WGS feed heater. The H₂-enriched syngas, in turn, upon exiting the WGS feed/effluent exchanger may be cooled, as a cooled H₂-enriched syngas, to a temperature the range from about 175° C. (347° F.) to about 300° C. (572° F.), such as from about 200° C. (392° F.) to about 250° C. (482° F.). These lower temperatures are more favorable for inlet conditions of the ammonia scrubber and thereby can reduce the duty associated with, or possibly eliminate the need for, added cooling upstream of this operation, such as provided by an auxiliary WGS effluent cooler. In some cases, however, such cooler may be utilized to provide a more desirable temperature of gas entering the ammonia scrubber, for example in the range from about 100° C. (212° F.) to about 225° C. (437° F.), such as from about 125° C. (257° F.) to about 200° C. (392° F.)

### Chloride Guard Bed or Guard Bed for Removal of Contaminants Generally

A chloride guard bed, containing a solid bed of material, may be used to supplement the chloride removal obtained in the chloride scrubber, and thereby provide a WGS feed, directly entering the WGS operation (e.g., a reactor of this operation), having a total chloride content that is essentially negligible, such as less than about 100 parts per billion by weight (wt-ppb), or even less than about 10 wt-ppb. The adverse effects associated with chloride contamination (e.g., poisoning) of catalyst used in the WGS operations are thereby overcome. Suitable solid bed materials include sorbents having both capacity for adsorbing chloride and the ability to withstand elevated temperatures associated with the WGS feed. Materials containing calcium carbonate (CaCO₃) and/or other minerals containing basic anions such as carbonate and hydroxide may be used for this purpose. More generally, and with reference to the drawing figures, the chloride guard bed may be a guard bed 85 for removal of chloride and/or any other contaminants from WGS feed 32 to improve its quality for processing in WGS operation 90. For example, guard bed 85 may remove any of chlorides, sulfur, and/or solid particulates, thereby leaving only trace quantities, or none, of one or more of these contaminants in WGS feed 32. One or multiple types of materials may be used in guard bed 85 to achieve a given purification objective.

### WGS Operation

The water gas shift (WGS) operation reacts CO present in a WGS feed, for example following heating in a WGS feed/effluent heat exchanger and supplemental chloride removal in a chloride guard bed as described above, with steam to increase H₂ concentration (as well as CO₂ concentration) in the H₂-enriched effluent provided by, or exiting, this operation. This heating and supplemental chloride removal render the properties of WGS feed more favorable for use in the WGS operation. In view of the chloride guard bed not substantially impacting process temperature, the WGS feed directly entering the WGS operation (e.g., a reactor of this operation) may have a temperature in a range as described above with respect to the heated WGS-feed portion.

In the WGS operation, the use of steam in excess of the stoichiometric amount may be beneficial, particularly in adiabatic, fixed-bed reactors, for a number of purposes. These include driving the equilibrium toward hydrogen production, adding heat capacity to limit the exothermic temperature rise, and minimizing side reactions, such as methanation. In this regard, a supplemental source of steam, adding to that present in the WGS feed, may be combined with this feed. The supplemental source of steam may be readily available through generation in the process, or it may be external to the process. In a preferred embodiment, at least a portion of steam (e.g., high or medium pressure steam) generated a CSC or radiant syngas cooler may be fed or added to the WGS operation (e.g., to one or more reactors used in this operation), thereby improving overall heat balancing/integration.

Reactors used in a WGS operation may contain a suitable catalyst, such as those comprising one or more of Co, Ni, Mo, and W on a solid support, particular examples of which are Co/Mo and Ni/Mo catalysts that exhibit sulfur tolerance. Other catalysts for use in this operation (i.e., contained within one or more WGS reactors) include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃—Cr₂O₃ catalysts).

In a typical WGS operation, two or more reactors with interstage cooling are used in view of the thermodynamic characteristics of the WGS reaction. For example, a high-temperature shift (HTS) reactor may operate with a temperature of the reactor inlet from about 310° C. (590° F.) to about 450° C. (842° F.), with more favorable reaction kinetics but a less favorable equilibrium conversion. The effluent from the HTS may then be cooled to a temperature suitable for the reactor inlet of a low-temperature shift (LTS) reactor, such as from about 200° C. (392° F.) to about 250° C. (482° F.), for providing less favorable reaction kinetics but a more favorable equilibrium conversion, such that the combined effect of the HTS and LTS reactors results in a high conversion to H₂ with a favorable residence time. In some cases, it may be desirable to use three or more reactors, or catalyst beds, to perform the WGS reaction, again with cooling between consecutive reactors or catalyst beds.

In this manner, the WGS operation may be used to provide an H₂-enriched syngas exiting, or obtained directly from, this operation and having an increased H₂:CO molar ratio and increased H₂ concentration, relative to the WGS feed, or otherwise relative to any synthesis gas obtained from upstream operations (e.g., filtered gasifier effluent or chloride-depleted gasifier effluent). For example, the H₂-enriched syngas may have an H₂:CO molar ratio from about 0.5 to about 3.5, from about 1.0 to about 3.0, or from about 1.5 to about 2.5 and/or a hydrogen concentration of at least about 35 mol-% (e.g., from about 35 mol-% to about 80 mol-%), at least about 40 mol-% (e.g., from about 40 mol-% to about 70 mol-%), or at least about 45 mol-% (e.g., from about 45 mol-% to about 65 mol-%). These characteristics of the H₂-enriched syngas may be controlled by bypassing the WGS operation to a greater or lesser extent (e.g., diverting a smaller or larger portion of the WGS feed to this operation, around this operation to provide a portion of the H₂-enriched syngas). The WGS operation may be further beneficial in terms of converting carbonyl sulfide (COS) to H₂S which can be recycled and more easily removed elsewhere in the process, such as in an acid gas removal operation or possibly, at least to some extent, in the chloride scrubber and/or ammonia scrubber. Due to the exothermic nature of the WGS reaction, the temperature of the H₂-enriched syngas, in representative embodiments, may be from about 275° C. (527° F.) to about 500° C. (932° F.), such as from about 300° C. (572° F.) to about 475° C. (887° F.).

### Ammonia Scrubber

An ammonia scrubber may be used to remove ammonia (NH₃) from syngas, such as a bypass portion of the chloride-depleted syngas that is not subjected to the WGS operation and/or a cooled H₂-enriched syngas provided from the WGS operation, following cooling in a WGS feed/effluent exchanger and optionally an auxiliary WGS effluent cooler. This removal may be achieved through contacting with a suitable aqueous stream, such as an aqueous ammonia scrubber feed. Contacting may be performed in a counterflow manner, with the aqueous ammonia scrubber feed entering, and the chloride-depleted syngas exiting, at or near the top of a vertically oriented (e.g., elongated cylindrical) ammonia scrubber vessel. Contacting efficiency may be promoted by the use of internal structures, such as suitable packing material with a high surface area or discreet vapor-liquid contacting trays. Other types of contacting, such as bubbling of gas through the aqueous ammonia scrubber feed (e.g., batchwise), co-current contacting, etc., may be carried out with the same result of obtaining a treated syngas having a reduced amount (weight percentage or concentration) of both HCl (or total chloride) and NH₃ (or total nitrogen), relative to that of the gasifier effluent (e.g., filtered gasifier effluent) being fed to the chloride scrubber. Generally, the ammonia scrubber is selective for removal of ammonia over other types of water-soluble contaminants such that, for example, ammonia removal efficiency, under conditions present in the ammonia scrubber, exceeds chloride removal efficiency. However, this operation may nonetheless be effective for removing at least some water-soluble contaminants (e.g., H₂S and/or HCN), other than ammonia. The ammonia scrubber may be used to provide a treated syngas exiting, or obtained directly from, this operation and having a total NH₃ (or total nitrogen) content of less than about 10 wt-ppm, less than about 1 wt-ppm, and possibly less than about 0.1 wt-ppm, as well as having a total HCl (or total chloride) content within a range as described above with respect to the chloride-depleted syngas.

The ammonia scrubber may provide further cooling of the gas being fed to this operation, for example cooling beyond that achieved in a WGS feed/effluent exchanger and optionally an auxiliary WGS effluent cooler, upstream of this operation. In representative embodiments, a treated syngas product exiting the ammonia scrubber may have a temperature in the range from about 35° C. (95° F.) to about 100° C. (212° F.), such as from about 40° C. (104° F.) to about 60° C. (140° F.).

### Syngas Conversion or Separation Operations

In some embodiments, processes described herein may also include a syngas conversion operation or syngas separation operation to produce a respective renewable syngas conversion product or renewable syngas separation product, such as liquid hydrocarbons, methanol, or RNG as examples of conversion products, and purified hydrogen as an example of a separation product. Such syngas conversion operation or syngas separation operation may be fed directly by synthesis gas stream as described herein, such as a treated syngas product. In the case of liquid hydrocarbon production, the syngas conversion operation may comprise a Fischer-Tropsch (FT) reaction stage. One or more reactors in this stage are used to process the synthesis gas mixture of hydrogen (H₂) and carbon monoxide (CO) by successive cleavage of C—O bonds and formation of C—C bonds with the incorporation of hydrogen. This mechanism provides for the formation of hydrocarbons, and particularly straight-chain alkanes, with a distribution of molecular weights that can be controlled to some extent by varying the FT reaction conditions and catalyst properties. Such properties include pore size and other characteristics of the support material. The choice of FT catalyst and its active metals (e.g., Fe or Ru) can impact FT product yields in other respects, such as in the production of oxygenates.

In the case of methanol production, the syngas conversion operation may comprise a methanol synthesis reaction stage. One or more reactors in this stage are used to form methanol according to the catalytic reaction:

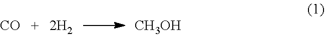

Representative catalysts for the synthesis of methanol by this route are characterized by “CZA,” which is a reference to copper and zinc on alumina, or Cu/ZnO/Al₂O₃. Alternatively, or in combination, various other catalytic metals and their oxides may be used, including one or more of W, Zr, In, Pd, Ti, Co, Ga, Ni, Ce, Au, Mn, and their combinations.

In the case of methane production as a syngas conversion operation to provide a renewable natural gas (RNG) product, one or more methanation reactors (e.g., in series or parallel) may be used to react CO and/or CO₂ with hydrogen and thereby provide a hot methanation product having a significantly higher concentration of methane relative to that initially present (e.g., in the WGS product). Catalysts suitable for use in a methanation reactor include supported metals such as ruthenium and/or other noble metals, as well as molybdenum and tungsten. Generally, however, supported nickel catalysts are most cost effective. Often, a methanation reactor is operated using a fixed bed of the catalyst.

In the case of purified hydrogen production, the syngas separation operation may comprise a renewable hydrogen separation stage that can utilize, for example, (i) an adsorbent in the case of separation by PSA or (ii) a membrane. Combinations of such stages may be used in a given syngas separation operation. In any such operation, a gaseous separation byproduct is also provided that is generally enriched in the non-hydrogen components of syngas, such as CO, CO₂, and/or H₂O. This byproduct may be, for example, a PSA tail gas or otherwise a membrane permeate or retentate, depending on the particular membrane used and consequently whether the renewable hydrogen separation product is recovered as the membrane retentate or permeate. This hydrogen, obtained as a result of utilizing a syngas separation operation downstream of the WGS operation, may, in some embodiments, be characterized as high purity hydrogen (e.g., having a purity of at least about 99 mol-% or more, such as at least 99.9 mol-% or at least 99.99 mol-%).

### Further Exemplary Embodiments of Gasification Processes

FIG. 1 depicts a flowscheme illustrating an embodiment of a process including operations as described above. According to this embodiment, in gasifier 50, carbonaceous feed 10 is combined with oxygen-containing gasifier feed 14 under gasification conditions to provide a gasifier effluent, in this case raw gasifier effluent 16 comprising synthesis gas. Oxygen-containing gasifier feed 14 alone, or possibly in combination with a supplemental source of steam (not shown), may comprise H₂O and O₂, as well as optionally CO₂, in a combined concentration of at least about 90 mol-%, at least about 95 mol-%, or at least about 99 mol-%.

Raw gasifier effluent 16 is fed to tar removal operation 55, which provides tar-depleted gasifier effluent 18, having a lower amount of tar relative to raw gasifier effluent 16. The very high temperatures of tar-depleted gasifier effluent, as described herein, resulting from tar removal operation, will generally mandate the use of one or more direct or indirect cooling operations. For example, according to the specific embodiment illustrated in FIG. 1, quenching operation 60, as a direct cooling operation, may be used in conjunction with convective syngas cooler (CSC) 65, as an indirect cooling operation. Quenching operation 60 may be more particularly a partial dry quench (PDQ) operation, for contacting (e.g., by direct contact), tar-depleted gasifier effluent 18 with quench water 20. This provides quenched gasifier effluent 22, having a temperature that is decreased relative to that of tar-depleted gasifier effluent 18. The process may additionally comprise, in CSC 65, further cooling quenched gasifier effluent 22, such as by indirect, heat-exchanging contact with boiler feed water 25. This provides cooled gasifier effluent 24 and CSC-generated steam 23. Subjecting cooled gasifier effluent 24 to filtration operation 70 provides filtered gasifier effluent 26, having a reduced content of particulates. The use of chloride scrubber 801, for contacting filtered gasifier effluent 26 or other gasifier effluent with aqueous chloride scrubber feed 106 (FIG. 2), provides chloride-depleted syngas 28, having a reduced content of total HCl (or total chloride), in addition to aqueous chloride scrubber product 107 (FIG. 2) having an increased content of total HCl (or total chloride), relative to aqueous chloride scrubber feed 106. In general, the gasifier effluent, prior to contacting in chloride scrubber 801, is provided from gasifier 50 following one or more intervening operations, between gasifier 50 and chloride scrubber 801. These intervening operations may include, for example, one or more of tar removal operation 55, a direct cooling operation such as quenching operation 60, an indirect cooling operation such as CSC 65, and filtration operation 70.

As further illustrated in FIG. 1, a first portion of chloride-depleted syngas 28, namely WGS-feed portion 28a is fed to WGS operation 90, through WGS feed/effluent exchanger 75 that provides heated WGS-feed portion 30, and through chloride guard bed 85 that provides WGS feed 32. Accordingly, in various particular embodiments, the first portion of the chloride-depleted syngas 28, prior to feeding to WGS operation 90, is heated by exchanging heat with H₂-enriched syngas 34 from WGS operation 90. Further heating upstream of WGS operation, if necessary, may be provided using auxiliary WGS feed heater 110. This first portion of the chloride-depleted syngas 28 may alternatively, or in combination, be contacted with chloride guard bed 85, for example containing a material as described above, to further remove chloride, beyond the degree of removal provided by chloride scrubber 801.

From WGS operation 90, H₂-enriched syngas 34 is obtained, which is contacted in ammonia scrubber 802 with an aqueous ammonia scrubber feed 101 (FIG. 2) to provide treated syngas product 111. Prior to this contacting, H₂-enriched syngas 34 is cooled by exchanging heat, indirectly, with WGS-feed portion in WGS feed/effluent exchanger 75, to provide cooled H₂-enriched syngas 36. If necessary, further cooling upstream of ammonia scrubber may be provided using auxiliary WGS effluent cooler 120 (FIG. 2). At least a second portion, such as bypass portion 28b, of chloride-depleted syngas 28 may also be fed to ammonia scrubber 802, such as directly from chloride scrubber 801, but in any case without this bypass portion 28b being subjected to WGS operation 90 to increase its H₂ content. In this manner, bypassing of WGS operation 90 can be used to control the H₂ concentration and/or the H₂:CO molar ratio of the combined feed to ammonia scrubber 802 and also of treated syngas product 111 that can be used in syngas conversion operation 95. For example, representative processes may comprise adjusting a flow rate of the first portion (e.g., WGS-feed portion 28a) and/or the second portion (e.g., bypass portion 28b) of chloride-depleted syngas 28 to control (e.g., maintain) a setpoint H₂ concentration (e.g., any discreet value within the range of 30 vol-% to 70 vol-%) and/or a setpoint H₂:CO molar ratio (e.g., any discreet ratio with the range of 1:2 to 5:1) of treated syngas product 111. As illustrated in FIG. 1, bypass portion 28b and cooled H₂-enriched syngas 36 may be fed separately to ammonia scrubber 802, such as at separate axial heights. Alternatively, as illustrated in FIG. 2, these streams 28b, 36 may be combined upstream of ammonia scrubber 802. In general, representative process may comprise feeding to the ammonia scrubber 802, in addition to the second portion (e.g., bypass portion 28b) of chloride-depleted syngas 28, H₂-enriched syngas 34 from WGS operation 90, for contacting with aqueous ammonia scrubber feed 106 to provide treated syngas product 111. This product may then be fed to syngas conversion or syngas separation operation 95 to provide renewable gasification product 40, in view of treated syngas product 111 having more favorable properties, in terms of low contaminant levels and sufficient hydrogen content, for such operation 95.

Additional details are illustrated in FIG. 2, with respect to the flows of various aqueous feed and product streams to and from the chloride scrubber 801 and ammonia scrubber 802, which are highlighted. Also illustrated are various auxiliary heaters and coolers 110, 120, 130 that may be used and that can employ any suitable heat exchange medium, such as steam at a suitable pressure or cooling water at a suitable temperature. According to FIG. 2, additional integration between chloride scrubber 801 and ammonia scrubber 802 may be achieved in the case of aqueous chloride scrubber feed 106 including an aqueous product of ammonia scrubber 802, such as optionally first aqueous ammonia scrubber product 105. Alternatively, or in combination, makeup chloride scrubber water 104 may provide all or a portion of aqueous chloride scrubber feed 106. According to a more specific embodiment, first aqueous ammonia scrubber product 105 is withdrawn from an aqueous recycle loop of ammonia scrubber 802, which includes all or a portion of aqueous ammonia scrubber feed 101. In addition, second aqueous ammonia scrubber product 103 may be withdrawn from this recycle loop, for example to limit the accumulation of condensate and/or impurities. At least a portion of second aqueous ammonia scrubber product 103 may be used for cooling of the gasifier effluent, such as directly in quenching operation 60 and/or indirectly in CSC 65 or a radiant syngas cooler. It is further possible for first aqueous ammonia scrubber product 105 to be withdrawn from the aqueous recycle loop at a first temperature, namely a first ammonia scrubber product temperature, that is higher than a second temperature, namely a second ammonia scrubber product temperature, at which second aqueous ammonia scrubber product 103 is withdrawn. For example, first aqueous ammonia scrubber product 105, used to provide at least a portion of aqueous chloride scrubber feed 106, may be withdrawn at a temperature from about 50° C. (122° F.) to about 150° C. (302° F.), whereas second aqueous ammonia scrubber product may be withdrawn at a temperature from about 30° C. (86° F.) to about 50° C. (122° F.). Temperatures in the aqueous recycle loop may be governed by the particular operation of ammonia scrubber 802 and regulated to some extent using aqueous recycle loop cooler 130.

Overall, aspects of the invention relate to gasification processes utilizing separate scrubbers both upstream and downstream of a WGS operation to efficiently attain desired properties of a feed to this operation. Further advantages in terms of material and heat integration, reduced metallurgical requirements, and others are described herein. Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments illustrated and described herein are for illustrative purposes only, and not limiting of the invention as set forth in the appended claims.

1. A process for gasification of a carbonaceous feed, the process comprising:
in a gasifier, contacting the carbonaceous feed with an oxygen-containing gasifier feed, under gasification conditions, to provide a gasifier effluent comprising H₂, CO, and, as water-soluble contaminants, chlorides and ammonia,
in a chloride scrubber, contacting the gasifier effluent with an aqueous chloride scrubber feed to provide a chloride-depleted syngas, exiting a gas outlet of the chloride scrubber;
adjusting a temperature of the chloride-depleted syngas to control a setpoint moisture level (humidity) of the chloride-depleted syngas.

2. The process of claim 1, wherein the setpoint moisture level is from about 30 vol-% to about 70 vol-%.

3. The process of claim 1, wherein the temperature of the chloride-depleted syngas is from about 120° C. to about 200° C.

4. The process of claim 1, wherein the temperature of the chloride-depleted syngas is adjusted by varying a flow rate of the aqueous scrubber feed.

5. A process for gasification of a carbonaceous feed, the process comprising:
in a gasifier, contacting the carbonaceous feed with an oxygen-containing gasifier feed, under gasification conditions, to provide a gasifier effluent comprising H₂, CO, and, as water-soluble contaminants, chlorides and ammonia,
in a chloride scrubber, contacting the gasifier effluent with an aqueous chloride scrubber feed to provide a chloride-depleted syngas, exiting a gas outlet of the chloride scrubber;
feeding at least a first portion of the chloride-depleted syngas to a water-gas shift (WGS) operation to provide an H₂-enriched syngas; and
in an ammonia scrubber, contacting the H₂-enriched syngas with an aqueous ammonia scrubber feed to provide a treated syngas product.

6. The process of claim 5, wherein the H₂-enriched syngas, prior to contacting with the aqueous ammonia scrubber feed in the ammonia scrubber, is cooled by exchanging heat with the first portion of the chloride-depleted syngas.

7. The process of claim 6, wherein the H₂-enriched syngas, prior to contacting with the aqueous ammonia scrubber feed in the ammonia scrubber, is cooled by said exchanging heat with the first portion of the chloride-depleted syngas, in combination with an auxiliary WGS effluent cooler.

8. The process of claim 5, further comprising feeding at least a second portion of the chloride-depleted syngas to the ammonia scrubber.

9. The process of claim 5, wherein the aqueous chloride scrubber feed comprises an aqueous product of the ammonia scrubber.

10. The process of claim 9, wherein the aqueous product of the ammonia scrubber is a first aqueous ammonia scrubber product that is withdrawn from an aqueous recycle loop of the ammonia scrubber, the process further comprising withdrawing a second aqueous ammonia scrubber product from the aqueous recycle loop.

11. The process of claim 10, wherein at least a portion of the second aqueous ammonia scrubber product is used for directly or indirectly cooling of the gasifier effluent.

12. The process of claim 10, wherein the first aqueous ammonia scrubber product is withdrawn from the aqueous recycle loop at a first ammonia scrubber product temperature that is higher than a second ammonia scrubber product temperature at which the second aqueous ammonia scrubber product is withdrawn.

13. The process of claim 5, wherein the gasifier effluent, prior to contacting in the chloride scrubber, is provided from the gasifier following one or more intervening operations selected from a tar removal operation, a direct cooling operation, an indirect cooling operation, and a filtration operation.

14. A process for gasification of a carbonaceous feed, the process comprising:
in a gasifier, contacting the carbonaceous feed with an oxygen-containing gasifier feed, under gasification conditions, to provide a gasifier effluent comprising H₂, CO, and, as water-soluble contaminants, chlorides and ammonia,
in a chloride scrubber, contacting the gasifier effluent with an aqueous chloride scrubber feed to provide a chloride-depleted syngas, exiting a gas outlet of the chloride scrubber;
feeding at least a first portion of the chloride-depleted syngas to a water-gas shift (WGS) operation to provide an H₂-enriched syngas; and
feeding at least a second portion of the chloride-depleted syngas to an ammonia scrubber, without subjecting the second portion to the WGS operation.

15. The process of claim 14, wherein the first portion of the chloride-depleted syngas, prior to feeding to the WGS operation, is heated by exchanging heat with the H₂-enriched syngas.

16. The process of claim 15, wherein the first portion of the chloride-depleted syngas, prior to feeding to the WGS operation, is heated by said exchanging heat with the H₂-enriched syngas, in combination with an auxiliary WGS feed heater.

17. The process of claim 14, wherein the first portion of the chloride-depleted syngas, prior to feeding to the WGS operation, is contacted with a chloride guard bed to further remove chloride.

18. The process of claim 14, further comprising feeding, in addition to the second portion of the chloride-depleted syngas, the H₂-enriched syngas to the ammonia scrubber, for contacting with an aqueous ammonia scrubber feed to provide a treated syngas product.

19. The process of claim 18, further comprising adjusting a flow rate of the first portion and/or second portion of the chloride-depleted syngas to control a setpoint H₂ concentration or setpoint H₂:CO molar ratio of the treated syngas product.

20. The process of claim 18, further comprising feeding the treated syngas product to a syngas conversion operation or a syngas separation operation to provide a renewable gasification product.
